(19) United States
(12) Patent Application Publication
(10) Pub. No.: US 2005/0257751 A1
(43) Pub. Date: Nov. 24, 2005

(54) Infusion pump for large animals

(76) Inventors: James T. Jackson, St. Mary's, KS (US); Shawn A. Patterson, Monett, MO (US)

Correspondence Address: David R. Deal;Thompson Coburn LLP, One US Bank Plaza, St. Louis, MO, 63101-9928, US

(21) Appl. No.: 10/849,289

(22) Filed: May 19, 2004

(51) Int. Cl. A01K 29/00

(52) U.S. Cl. 119/651

(57) ABSTRACT

A method and apparatus for infusing fluid into a large animal. The infusion pump comprises an electric pump unit and a catheter. The catheter is in fluid communication with the pump unit and adapted for insertion into a fluid passageway of the animal. The pump unit is adapted to pump at least five hundred milliliters of fluid through the catheter and into the animal in one minute at a flow rate of at least five hundred milliliters per minute. The infusion pump can be packaged with a manual to make a kit. The manual provides instructions for use of the infusion pump to infuse fluid into an animal.

### SUMMARY OF THE INVENTION

One aspect of the present invention is a method of treating a large animal using fluid therapy. The method comprises providing an infusion pump and a suitable supply of fluid. The infusion pump has an electric pump unit in fluid communication with an intravenous catheter. An intravenous physiologically appropriate crystalloid solution, known by the acronym “IPACS”, is suitable as the supply of fluid for the fluid therapy. The method further comprises inserting the catheter into a venous passageway of the animal and operating the pump unit in a manner to infuse fluid into the venous passageway of the animal at a variable rate. The rate of infusion may be equal to that obtained by gravity infusion alone or may be increased to greater than five hundred millimeters per minute depending on the size of the intravenous catheter used.

Another aspect of the present invention is a kit having a pump unit packaged with a manual. The pump unit is capable of pumping at least five hundred milliliters of fluid (such as IPACS) per minute. The manual provides instructions for use of the pump unit to infuse fluid into an animal. The instructions explain the process of connecting the pump unit to a catheter inserted into a fluid passageway (such as a venous passageway) of the animal and operating the pump unit in a manner to infuse fluid into the fluid passageway of the animal at a rate of greater than five hundred milliliters per minute.

Another aspect of the present invention is an infusion pump for use with a large animal such as a horse or a cow. The infusion pump comprises an electric pump unit and a catheter. The catheter is in fluid communication with the pump unit and adapted for insertion into a fluid passageway (such as a venous passageway) of the animal. The infusion pump is adapted to pump at least five hundred milliliters of an intravenous physiologically appropriate crystalloid solution through the catheter and into the animal in one minute at a flow rate of at least five hundred milliliters per minute.

Other features and advantages will be in part apparent and in part pointed out hereinafter.

### BRIEF DESCRIPTION OF THE DRAWINGS

FIG. 1 is a perspective view of an infusion pump according to the present invention;

FIG. 2 is a top plan view of the device of FIG. 1;

FIG. 3 is an end plan view of the device of FIG. 1;

FIG. 4 is a representation of a kit incorporating a device as set forth in FIG. 1;

FIG. 5 is the device of FIG. 1 in use;

FIG. 6 is a front plan view of the pump unit in the device of FIG. 1.

Corresponding reference characters indicate corresponding parts throughout the several views of the drawings.

### DETAILED DESCRIPTION OF THE PREFERRED EMBODIMENTS

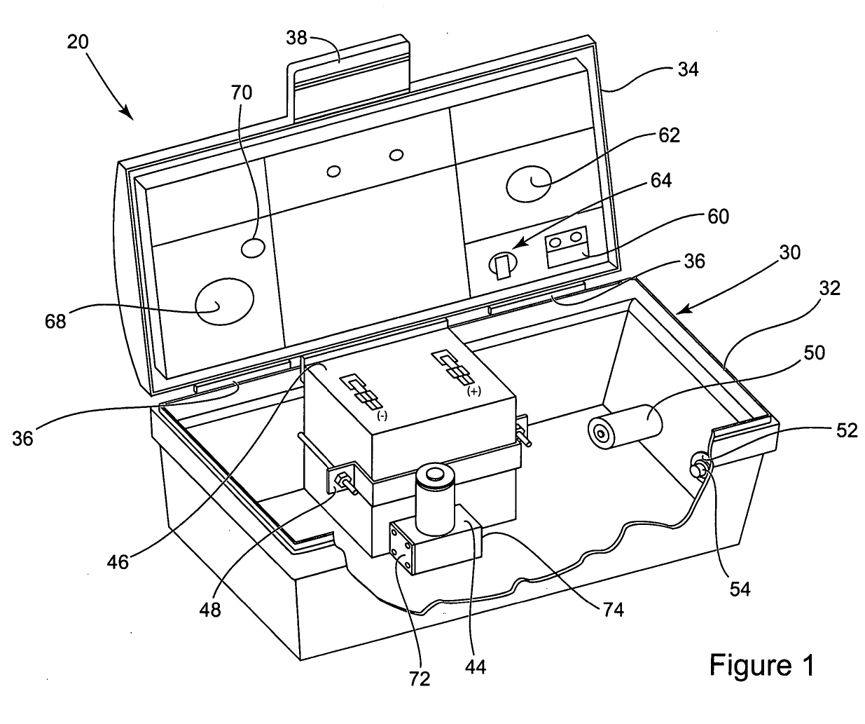

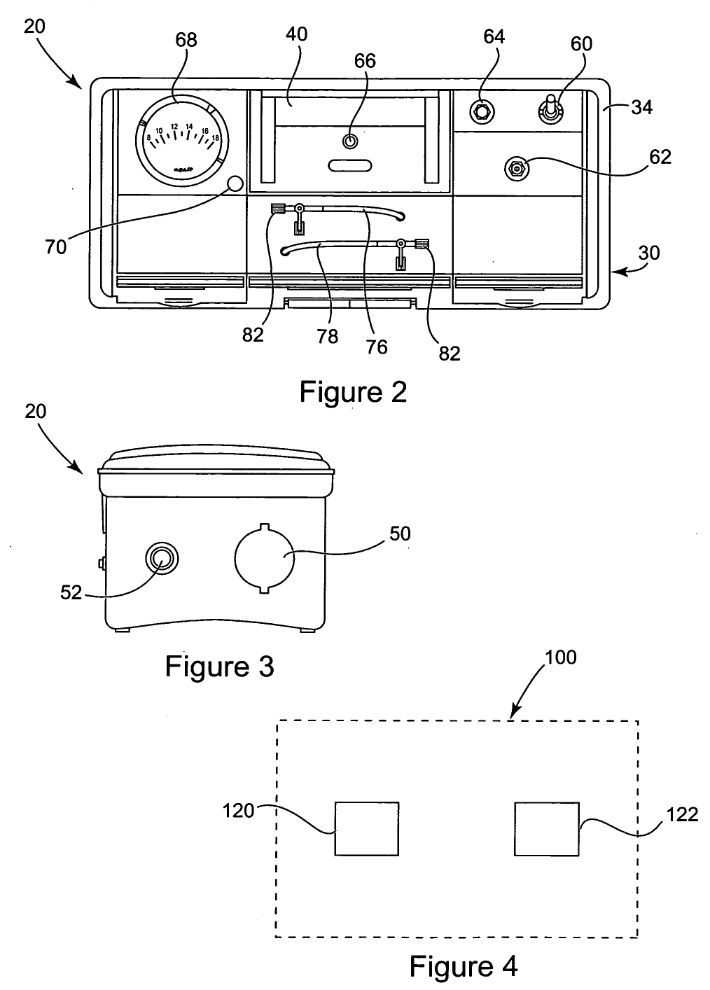

Referring now to the drawings, and more particularly to FIGS. 1 and 2, an infusion pump is shown generally at 20. The infusion pump is housed in a container 30. The container includes a base 32 and a lid 34. The lid is attached to the base by a pair of hinges 36 and is secured to the base by a latch 38. A handle 40 is attached to the lid 34 as shown in FIG. 2. The handle allows a user to carry the infusion pump 20 to a desired location for use. The container is preferably made of a rugged and durable material such as plastic.

The infusion pump 20 includes an adjustable pump unit 44 secured in the container 30. The pump unit 44 is preferably a medical grade peristaltic pump. The volume flow rate of the pump unit can be adjusted. The pump unit 44 is powered by a power source. The power source is preferably a rechargeable battery 46. A bracket 48 secures the battery to the container 30. The pump unit 44 can also connect to an additional power source. The additional power source can be either an alternating or direct current power source. The infusion pump 20 has a DC adapter 50 (shown in FIGS. 1 and 3) that is adapted to connect to a direct current additional power source such as another battery. The infusion pump also has an AC adapter 52 that is adapted to connect to an alternating current additional power source such as a 110 volt power supply. The AC adapter 52 includes an inverter to convert alternating current to direct current. The AC adapter 52 also includes a battery charger 54 that is adapted to charge the rechargeable battery 46 when connected to the alternating current additional power source and the pump unit 44 is not being operated.

Referring now to FIGS. 1 and 2, the infusion pump 20 includes a main switch 60 having an off setting and an on setting. When in the on setting the power source provides power to the pump unit 44. When in the off setting the power source does not power the pump unit 44. The infusion device also includes a flow regulator 62. The flow regulator is preferably a rheostat. The flow regulator is moveable between a minimum position and a maximum position and is adapted to control the volume flow rate of the pump unit 44 from a minimum flow rate to a maximum flow rate. The minimum flow rate of the pump unit 44 is preferably about three hundred milliliters per minute. The maximum flow rate of the pump unit 44 is preferably about twelve hundred milliliters per minute.

The infusion pump 20 may also include a priming switch 64, a power indicator light 66, a charge indicator 68, and a charge indicator switch 70. The priming switch is adapted to operate the pump unit 44 while the priming switch is engaged. The flow rate of the pump unit is not adjustable while the priming switch is engaged. Illumination of the power indicator light 66 indicates the main switch is in the on setting, the priming switch is engaged, or the infusion device is connected to an additional power source (the battery is being charged). The charge indicator 68 is adapted to display the amount of charge remaining in the rechargeable battery 46. The charge indicator is preferably a voltmeter but can be any other suitable device. The charge indicator switch connects the charge indicator to the rechargeable battery. Activation of the charge indicator switch allows a user to determine the amount of charge remaining in the rechargeable battery.

Although no wires are shown in FIG. 1 for clarity, the pump unit 44 is electrically connected to the power source, the additional power source, the priming switch, the main switch, the flow regulator, the power indicator light, and the charge indicator. The additional power source is electrically connected to the power source and adapted to provide power to the pump unit and the rechargeable battery. The priming switch is connected in parallel with the main switch such that either switch can power the pump unit. The charge indicator is connected to the rechargeable battery.

Referring now to FIGS. 1 and 6, the adjustable pump unit 44 has a pump inlet 72 and a pump outlet 74. The pump inlet provides an ingress for liquid to be drawn into the pump unit and the pump outlet provides an egress for liquid to be moved out of the pump unit. Although not shown in FIG. 1, an inlet tube 76 is in fluid communication with the pump inlet and an outlet tube 78 is in fluid communication with the pump outlet. The outlet tube can include a heat exchanger 80 that is adjacent to a motor portion of the pump unit. As shown in FIG. 2, the inlet and outlet tubes 76, 78 extend outside of container 30. The inlet tube is adapted to be connected in fluid communication with a supply line and the outlet tube is adapted to be connected in fluid communication with a delivery line. To facilitate these connections, the inlet and outlet tubes may be equipped with a three way stopcock 82. The three way stopcock allows the introduction of an additional fluid such as a medication.

In use, the infusion pump 20 is connected to a suitable supply of fluid. An intravenous physiologically appropriate crystalloid solution, known by the acronym “IPACS”, is suitable for fluid therapy. The supply of fluid will normally have a supply line. The supply line is fluidly connected to the inlet tube placing the supply of fluid in fluid communication with the infusion pump 20. The outlet line tube is then fluidly connected to a delivery line. The delivery line can then be connected as needed to deliver the fluid from the supply of fluid. The infusion device is then ready to be primed. Activation of the priming switch connects the pump unit to the power source to initiate operation of the pump unit. The pump unit creates a vacuum to begin drawing fluid into the supply line. The fluid will move through the supply line to the inlet tube and into the pump unit. The pump unit will move the liquid out of the pump into the outlet tube and then to the delivery line to complete the priming (at which point the priming switch can be de-activated). This process removes air from the supply line, inlet tube, pump unit, outlet tube, and delivery line. The main switch is then moved to the on position to begin delivery of the fluid as needed.

To control the amount of fluid delivered by the infusion pump the flow regulator 62 is used to increase or decrease the volume flow rate of the pump unit. In addition, the cross sectional area of the delivery line and catheter affects the amount of fluid delivered. The larger the diameter the greater the amount of fluid delivered at a particular setting of the flow regulator. Accordingly, the amount of fluid delivered by the infusion pump is determined by both the flow regulator and the size of the delivery line and catheter.

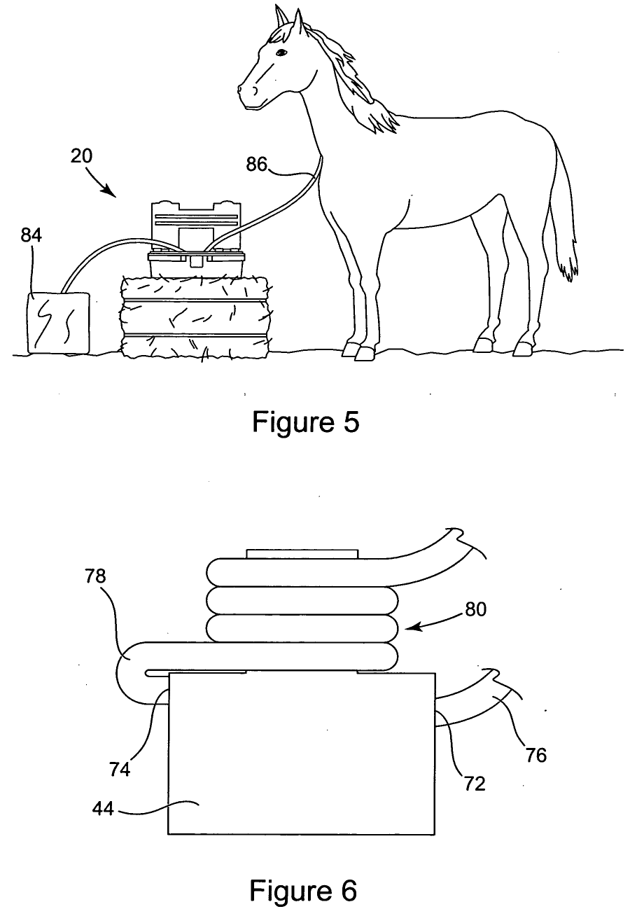

Referring now to FIG. 5, the infusion pump 20 is shown in use to treat a large animal (in this case a horse). A supply of IPACS has been provided. The supply of IPACS can be prepared on location with a supply of filtered water and a supply of concentrate. Different solutions can be prepared using different types of concentrates (such as cleaning, rinsing, or saline solutions). The supply of IPACS shown in FIG. 5 is a saline solution. The infusion pump 20 is connected to the supply of IPACS and the infusion pump 20 is then primed. The animal has an I-V hookup inserted into a venous passageway such as the jugular vein. The I-V hookup is a standard veterinarian hookup including but not limited to a catheter, a bubble trap, and a connector. The primed delivery line is then fluidly connected to the I-V hookup. The main switch is placed in the on setting and IPACS begins to flow into the jugular vein of the animal. The flow regulator is used to adjust the volume flow rate to the desired level.

Frequently, the amount of time necessary to treat an animal is critical to a successful treatment. This is especially true when the treatment involves fluid therapy. Fluid therapy can be used to restore and maintain hydration, tonicity, electrolyte balance, and pH balance. Fluid therapy can be used in emergency situations to treat hypovolemic shock and severe dehydration. In some situations, animals die before sufficient fluids can be administered. This frequently occurs when fluid is administered using a gravity feed system. The volume flow rate is increased by using multiple IV lines. This is not desirable because of the increased sites for infection. In situations where a large volume (such as ten liters) of fluid is to be administered, a gravity feed type device could take three to five hours as compared to the ten to twenty five minutes it could take with the infusion pump of FIG. 1.

The rugged construction and portable design of the infusion pump is very versatile when time is critical as discussed above. The veterinarian can travel to a remote location to treat an animal. This eliminates the need for a time consuming and stressful transport of the distressed animal. The infusion pump can be used to treat multiple animals before it is necessary to charge the rechargeable battery.

As seen in FIG. 4, the infusion pump 120 is preferably included with a manual 122 to create a kit 100. The manual can be in any medium suitable for conveying instructions including, for example, a booklet providing written instructions, an audio and/or video tape providing written, audible or visual instructions, a CD rom or a DVD providing written, audible or visual instructions, a website providing written, audible or visual instructions, or a package insert providing reference to literature articles that detail the method of the present invention or any other medium conveying instructions for performing the method of the present invention. The instructions can include directions for using the infusion pump to infuse fluid into a large animal. The instructions can also include directions for using the infusion pump to irrigate a wound on an animal. The instructions can also include directions for cleaning and sterilizing the infusion pump. The instructions can also include directions for using the infusion pump to provide vacuum removal of material from an animal.

As various changes could be made in the above constructions and methods without departing from the scope of the invention, it is intended that all matter contained in the above description or shown in the accompanying drawings shall be interpreted as illustrative and not in a limiting sense. Thus, the breadth and scope of the present invention should not be limited by any of the above-described exemplary embodiments, but should be defined only in accordance with the following claims appended hereto and their equivalents.

1. A method of treating a large animal comprising:
providing an infusion pump having an electric pump unit and a catheter in fluid communication with the pump unit;
providing a supply of fluid;
inserting the catheter into a fluid passageway of the animal;
operating the pump unit in a manner to infuse the fluid into the fluid passageway of the animal at a rate of greater than five hundred milliliters per minute.

2. A method as set forth in claim 1 wherein the infusion pump further has an intravenous hook-up, the catheter being a component of the intravenous hook-up, and the step of inserting the catheter into a fluid passageway of the animal further comprises inserting the catheter of the intravenous hook-up into a venous passageway of the animal.

3. A method as set forth in claim 1 wherein the providing a supply of fluid step further comprises providing a supply of fluid wherein the fluid is an intravenous physiologically appropriate crystalloid solution.

4. A method as set forth in claim 1 wherein the step of operating the pump unit comprises operating the pump unit in a manner to infuse at least five hundred milliliters of fluid into the animal in one minute.

5. A method as set forth in claim 1 wherein the step of operating the pump unit comprises operating the pump unit in a manner to infuse at least ten thousand milliliters of fluid into the animal in less than twenty minutes.

6. A method as set forth in claim 1 wherein the step of operating the pump unit comprises operating the pump unit in a manner to infuse at least one thousand milliliters of fluid into the animal in two minutes.

7. A method as set forth in claim 1 wherein the step of operating the pump unit comprises operating the pump unit in a manner to infuse at least one thousand milliliters of fluid into the animal in one minute.

8. A method as set forth in claim 1 wherein the step of operating the pump unit comprises operating the pump unit in a manner to infuse at least five hundred milliliters of fluid into the animal in less than one minute.

9. A method as set forth in claim 1 wherein the pump unit is a peristaltic pump.

10. A method as set forth in claim 1 further comprising:
providing a supply of cleaning solution and a supply of rinsing solution;
disconnecting the infusion pump from the animal and the supply of fluid;
connecting the infusion pump to the cleaning solution;
operating the infusion pump to pump cleaning solution through the infusion pump;
disconnecting the infusion pump from the cleaning solution;
connecting the infusion pump to the rinsing solution; and
operating the infusion pump to pump rinsing solution through the infusion pump.

11. A method as set forth in claim 1 wherein the infusion pump includes a three-way stopcock in fluid communication with the pump unit and the catheter and the method further comprises:
adding a medication via the three way stopcock to the fluid being infused into the animal.

12. A kit comprising an electric pump unit capable of pumping at least five hundred milliliters of fluid per minute packaged with a manual providing instructions for use of the pump unit to infuse fluid into an animal by fluidly connecting the pump unit to a catheter inserted into a fluid passageway of the animal and operating the pump unit in a manner to infuse fluid into the fluid passageway of the animal at a rate of greater than five hundred milliliters per minute.

13. An infusion pump for use with a large animal such as a horse or a cow, the infusion pump comprising:
an electric pump unit and a catheter, the catheter being in fluid communication with the pump unit, the catheter being adapted for insertion into a venous passageway of the animal, the pump unit being adapted to pump at least five hundred milliliters of an intravenous physiologically appropriate crystalloid solution through the catheter and into the animal in one minute at a flow rate of at least five hundred milliliters per minute.

14. An infusion pump as set forth in claim 13, the infusion pump further comprising a flow regulator adapted to enable a user to vary the flow rate of the infusion pump.

15. An infusion pump as set forth in claim 14 wherein the flow regulator and pump unit are adapted to permit a user to vary the flow rate of the pump unit between five hundred milliliters per minute and a maximum flow rate, the maximum flow rate being at least one thousand milliliters per minute.

16. An infusion pump as set forth in claim 14 wherein the flow regulator and pump unit are adapted to permit a user to vary the flow rate of the pump unit between five hundred milliliters per minute and a maximum flow rate, the maximum flow rate being about one thousand two hundred and fifty milliliters per minute.

17. An infusion pump as set forth in claim 13 wherein the pump unit is a peristaltic pump.

18. An infusion pump as set forth in claim 13 further comprising a heat exchanger adjacent the pump unit, the heat exchanger being adapted to heat the fluid being pumped through the catheter.

19. An infusion pump as set forth in claim 13 comprising an intravenous hook-up, the catheter being a component of the intravenous hook-up, the intravenous hook-up being adapted to fluidly connect a venous passageway of the animal to the pump unit.

20. An infusion pump as set forth in claim 19 wherein the intravenous hook-up includes a bubble trap and the catheter, the bubble trap being adapted to eliminate bubbles in the intravenous physiologically appropriate crystalloid solution.

21. An infusion pump as set forth in claim 13 further comprising a three way stop cock in fluid communication with the pump unit and the catheter, the three way stop cock being adapted to enable a user to introduce an additional fluid into the animal via the intravenous physiologically appropriate crystalloid solution being delivered by the pump unit.
